(19) United States
(12) Patent Application Publication
(10) Pub. No.: US 2018/0370637 A1
(43) Pub. Date: Dec. 27, 2018

(54) ELECTROTHERMAL ICE PROTECTION SYSTEMS WITH CARBON ADDITIVE LOADED THERMOPLASTIC HEATING ELEMENTS

(71) Applicant: Goodrich Corporation, Charlotte, NC (US)

(72) Inventors: Jin Hu, Hudson, OH (US); Galdemir Cezar Botura, Akron, OH (US); Casey Slane, Richwood, OH (US)

(21) Appl. No.: 15/630,250

(22) Filed: Jun. 22, 2017

(51) Int. Cl. B64D 15/12; H05B 3/14; H05B 3/26

(52) U.S. Cl. CPC B64D 15/12; B64D 33/02; H05B 3/267; H05B 3/145

(57) ABSTRACT

Pre-fabric, flexible and thermally stable plastic sheets are loaded with carbon additives such as carbon nanotubes (CNTs), graphene, nano carbon fibers, graphite powders, or other carbon allotropes to adjust the resistivity of the sheets as desired for ice protection. These sheets are both conformable to desired surfaces and prevent the carbon debris migration issues in traditional CNT heaters.

### BACKGROUND

An aircraft moving through the air is often subjected to ice formation, and anti-icing or de-icing devices must be used to remove or prevent ice from accumulating on exterior surfaces of the aircraft. Various types of ice protection systems have been developed to protect aircraft from the hazardous effects of icing. Electro-thermal de-icing systems typically use metal resistor heaters to melt ice by converting electrical energy to thermal energy.

Carbon nanotube (CNT) materials have been proposed as an alternative to metal wire or foil heating elements in ice protection systems. CNTs are carbon allotropes having a generally cylindrical nanostructure. They have unusual properties that make them valuable for many different technologies. For instance, some CNTs heating elements can have high thermal and electrical conductivity, making them suitable for replacing metal heating elements. Due to their much lighter mass, substituting CNTs for metal heating components can reduce the overall weight of a heating component significantly. Furthermore CNT heaters have low thermal mass, therefore it has a potential to heat up and cool fast and save peak power. These make the use of CNTs of particular interest for aerospace electrothermal de-icing applications.

However, carbon-based fabric heating elements for ice protection are subject to carbon debris migration across the heating element during heater fabrication. The resulting heater may have electric short or liable to dielectric breakdown due to the CNT particles migration.

### SUMMARY

An electrothermal ice protection article includes a thermally stable thermoplastic sheet containing a carbon allotrope additive.

A method of making an electrothermal ice protection system includes creating a polymer and carbon additive mixture, forming a thermoplastic sheet from the polymer and carbon additive mixture, and post-treating the polymer and carbon additive mixture.

### BRIEF DESCRIPTION OF THE DRAWINGS

FIG. 1 is a schematic view of a carbon additive loaded electrothermal ice protection heating element.

FIG. 2 is a schematic diagram of an ice protection system with a carbon additive loaded electrothermal ice protection heating element.

FIG. 3 is a flow chart depicting a method of making a carbon additive loaded electrothermal ice protection system.

### DETAILED DESCRIPTION

Carbon-based fabric heating elements for ice protection can contain carbon nanotubes, graphite fibers, graphite nanofibers or graphene. These fabrics can be prepared as pre-impregnated fabrics with thermosetting polymers such as epoxy resins. Alternatively, these fabrics can be coupled with thermosetting film adhesives to allow multiple plies or attachments to metal skins. These CNT fabric heating elements can form de-icer or anti-icer assemblies. In a given carbon-fiber based composite layer heating element, carbon debris have a tendency to migrate between plies, for instance between layers of a heating element and airfoil skins or between heating elements, causing electric shorting. They are additionally liable to dielectric breakdown. If these carbon based fabrics are pre-cured as a pre-impregnated layer before being cured with other plies and layer, the CNT heating element usually has a lack of conformability for de-icing surfaces. Additionally, carbon-based fabrics cannot be tailored to specific resistivity once cured.

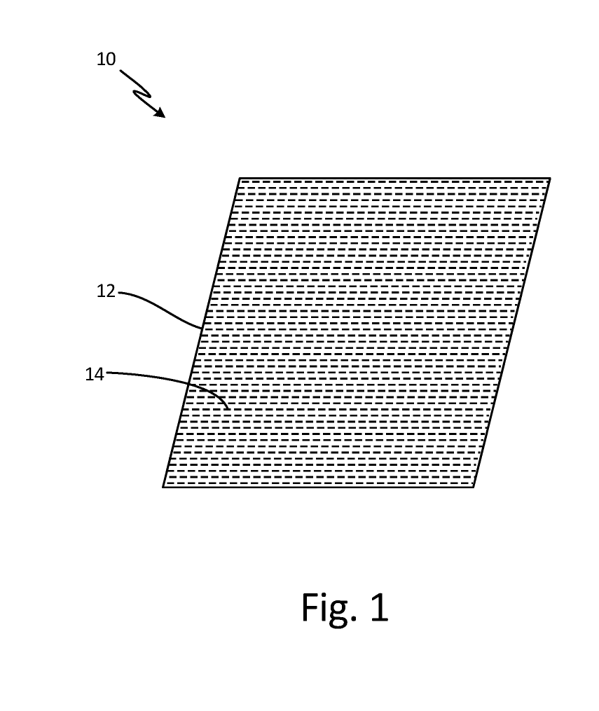

The present disclosure concerns the use of thermally stable thermoplastic sheets containing carbon allotropes for heating elements. This construction of the sheet prevents migration of carbon debris across layers within the structure of a composite ice protection system. FIG. 1 is a schematic view of a carbon additive loaded electrothermal ice protection heating element. Heating element 10 includes thermoplastic 12 and carbon additives 14.

Thermoplastic 12 is a thermally stable plastic, such as a polyetherether ketone (PEEK), polyetherimide (PEI), polyethlylene (PE), polyether sulfone (PES), polylactic acid (PLA), Nylon®, polyethylene-naphthalate (PEN), polybenzimidazole (PBI), polyimide (PI), poly methyl methacrylate (PMMA), or combinations thereof. Thermoplastic 12 should be thermally stable.

Carbon additives 14 can be carbon nanotubes, graphene, carbon nanofibers, graphite powder, graphene nanoribbons, or other appropriate electrically conductive material for carbon-based heating elements. Carbon additives 14 can be loose particles added to thermoplastic 12, or can be a carbon fabric to which thermoplastic 12 is applied.

Resulting heating element 10 is used for ice protection. Due to its thermoplastic nature, heating element 10 can be applied to surfaces with varying shapes, such as airfoils, nacelle components, and other areas of an aircraft needing ice protection. Heating element 10, when used as a ply in a composite heating element, or combined with multiple carbon-based heating element layers, limits carbon debris migration. The amount of carbon additives added into heating element 10, and the amount of CNT heating elements in an assembly, can be readily varied to change resistivity or sheet resistivity. Thermoplastic 12 holds carbon additives 14 in place, whether carbon additives 14 are woven, unwoven or randomly distributed. The resulting heating element can have electrical sheet resistivity between 0.005 ohms per square (C/sq) and 10 ohms per square (C/sq), preferably between 0.02 ohms per square (O/sq) and 3.0 Ω/sq.

Finally, handling of heating element 10 is airborne safer for an end user applying heating element 10 to an ice protection purpose. A person who is applied heating element 10 to a surface is not working directly with carbon nanotubes, carbon fibers, or other carbon additives as he would be with carbon fabrics used in previous heating systems. Instead, a handler is working with a thermoplastic sheet or strip. Thus, handling of heating element 10 is safer.

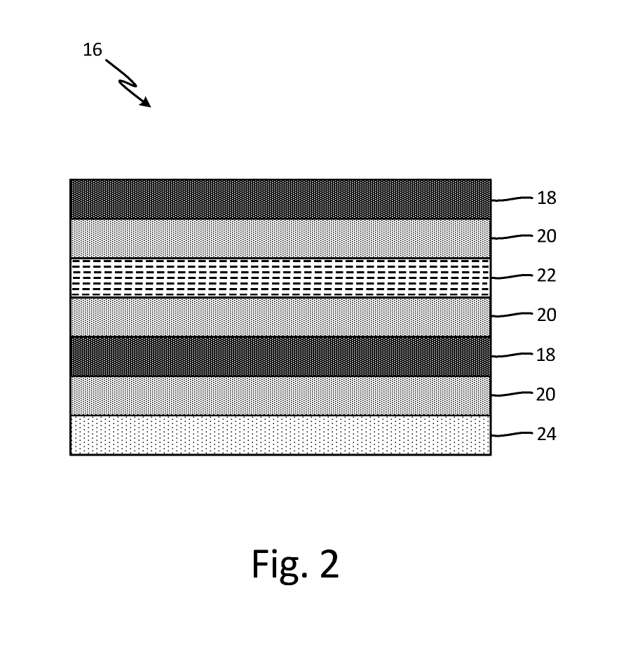

FIG. 2 is a schematic diagram of ice protection system 16 with a carbon additive loaded electrothermal ice protection heating element. System 16 includes fiberglass layers 18, film adhesive layers 20, carbon additive loaded electrothermal ice protection heating element 22, and skin layer 24. Heating element 22 is similar to heating element 10 of FIG. 1 in its composition. Heating element 10 is supported by fiberglass layers 18, and skin layer 24, which are adhered to heating element 22 by film adhesive layer 20. Skin layer 24 can be a metallic skin or a composite (such as a fiberglass or carbon fiber composite) suitable for ice protection.

Heating element 22 is a thermoplastic carbon heater and is being used in system 16 as the substructure of an airfoil. The coefficient of thermal expansion (CTE) of heating element 22 is compatible with other layers 18 and 24 to prevent delamination under thermal cycles, particularly between −55 and 85 degrees Celsius. Additionally, system 16 has a shear strength of at least 1500 PSI and sufficient bird and hail strike resistance.

The embodiment in FIG. 2 is representative of an ice protection assembly scheme. In other embodiment, fiberglass 18 can be replaced with, for example, dielectric films or other pre-impregnated materials. Additionally, the number of fiberglass layers 18 can be increased or decreased based on ice protection needs. In some embodiments, film adhesive layers 20 are not needed because pre-impregnated layers are sufficiently adhesive or if the ice protection application requires less stringent bonding requirements. Thus, ice protection system 16 can be altered depending on ice protection needs.

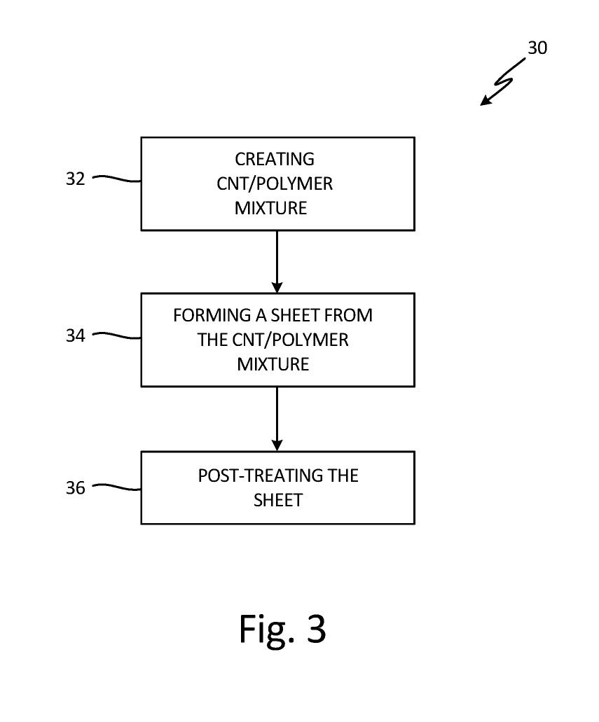

FIG. 3 is a flow chart depicting method 30 of making a carbon additive loaded electrothermal ice protection heating element. In method 30, a carbon-polymer mixture is made in step 32, a carbon-polymer sheet is formed in step 34, and the sheet is post-treated in step 36.

First, in step 32, a carbon-polymer mixture is made. The mixture contains a polymer, such as a polyetherether ketone (PEEK), polyetherimide (PEI), polyethlylene (PE), polyether sulfone (PES), polylactic acid (PLA), Nylon®, polyethylene-naphthalate (PEN), polybenzimidazole (PBI), polyimide (PI), poly methyl methacrylate (PMMA), or combinations thereof.

A carbon additive is integrated into the polymer by standard methods, such as by dissolving a base polymer resin and mixing in a carbon allotrope. Alternatively, a traditional plastic compounding process such as extrusion or internal mixing can be used. Appropriate carbon additives include, for example, carbon nanotubes, graphene, carbon nanofibers, graphite powder, graphene nanoribbons, or other appropriate electrically conductive material for carbon-based heating elements.

In step 34, a sheet is formed from the carbon-polymer mixture. If a method such as dissolution of a base polymer and mixing with a carbon allotrope is used, the mixture can be formed into a sheet and remaining solvent can be removed. If traditional plastic compounding processes are used, then a sheet can be created from a cast or blown extrusion film process. Alternatively, the polymer can be applied to a woven or non-woven carbon fiber sheet. Additionally, heating element 10 can be created as a three dimensional shape instead of a sheet by molding, allowing tailoring to large ranges of electrical resistivity.

In step 36, the sheet can be tailored in post-treatment processes as desired. The resulting carbon additive filled polymer can have a thickness of between 0.001 inches and about 0.010 inches, depending on a surface to which it will be applied for ice protection.

The resulting carbon additive filled polymer sheet is lightweight, electrically conductive, and does not cause carbon fiber migration problems when used in composite layers and its resistivity can be readily tailored by carbon additive loading.

### Discussion of Possible Embodiments

The following are non-exclusive descriptions of possible embodiments of the present invention.

An electrothermal ice protection article includes a thermally stable thermoplastic sheet containing a carbon allotrope additive.

The article of the preceding paragraph can optionally include, additionally and/or alternatively, any one or more of the following features, configurations and/or additional components:

The thermally stable thermoplastic sheet is made of a material selected from the group consisting of polyetherether ketones, polyetherimides, polyethlylenes, polyether sulfones, polylactic acid, nylon, polyethylene-naphthalates, polybenzimidazole, polyimides, poly methyl methacrylates and combinations thereof.

The carbon allotrope additive is selected from the group consisting of carbon nanotubes, graphene, carbon nanofibers, graphite powder, and graphene nanoribbons.

The article has a uniform thickness between 0.0005 inches and about 0.010 inches.

The article has a uniform thickness between 0.001 inches and 0.003 inches.

The article has a varying thickness.

The article has an electrical sheet resistivity between 0.005 ohms per square and 10.0 ohms per square.

The article has an electrical sheet resistivity between 0.02 ohms per square and 3.0 ohms per square.

The article has a first electrical resistivity in a first portion of the article, and a second electrical resistivity in a second portion of the articles; and wherein the first resistivity and the second resistivity differ.

A method of making an electrothermal ice protection system includes creating a polymer and carbon additive mixture, forming a sheet from the polymer and carbon additive mixture, and post-treating the polymer and carbon additive mixture.

The method of the preceding paragraph can optionally include, additionally and/or alternatively, any one or more of the following features, configurations and/or additional components:

Creating a polymer and carbon additive mixture comprises dissolving a base polymer resin and mixing the carbon additive into the base polymer resin.

Creating a polymer and carbon additive mixture comprises mixing a polymer resin and the carbon additive in a plastic compounding process.

The plastic compounding process comprises heating the polymer resin to allow incorporation of the carbon additive to create a film.

Forming a thermoplastic sheet from the polymer and carbon additive mixture is done by placing the film into a cast to form a sheet.

The thermoplastic sheet is made of a material selected from the group consisting of polyetherether ketones, polyetherimides, polyethlylenes, polyether sulfones, polylactic acid, nylon, polyethylene-naphthalates, polybenzimidazole, polyimides, poly methyl methacrylates and combinations thereof.

The carbon allotrope additive is selected from the group consisting of carbon nanotubes, graphene, carbon nanofibers, graphite powder, and graphene nanoribbons.

Forming a sheet comprises molding the mixture into a complex shape.

Forming a mixture comprises injection the polymer with the carbon additive.

An ice protection system includes a carbon heating element comprising a thermally stable thermoplastic sheet containing a carbon allotrope additive, a first fiberglass layer adhered to the carbon heating element by a film adhesive, a second fiberglass layer adhered to the carbon heating element opposite the first fiberglass layer by a film adhesive, and a skin layer adhered to the second fiberglass layer opposite the carbon heating element by a film adhesive.

The system of the preceding paragraph can optionally include, additionally and/or alternatively, any one or more of the following features, configurations and/or additional components:

The skin layer comprises a metallic layer or a composite layer.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An electrothermal ice protection article comprises a thermally stable thermoplastic sheet containing a carbon allotrope additive.

2. The article of claim 1, wherein the thermally stable thermoplastic sheet is made of a material selected from the group consisting of polyetherether ketones, polyetherimides, polyethlylenes, polyether sulfones, polylactic acid, nylon, polyethylene-naphthalates, polybenzimidazole, polyimides, poly methyl methacrylates and combinations thereof.

3. The article of claim 1, wherein the carbon allotrope additive is selected from the group consisting of carbon nanotubes, graphene, carbon nanofibers, graphite powder, and graphene nanoribbons.

4. The article of claim 1, wherein the article has a uniform thickness between 0.0005 inches and about 0.010 inches.

5. The article of claim 4, wherein the article has a uniform thickness between 0.001 inches and 0.003 inches.

6. The article of claim 1, wherein the article has a varying thickness.

7. The article of claim 1, wherein the article has an electrical sheet resistivity between 0.005 ohms per square and 10.0 ohms per square.

8. The article of claim 7, wherein the article has an electrical sheet resistivity between 0.02 ohms per square and 3.0 ohms per square.

9. The article of claim 1, wherein the article has a first electrical resistivity in a first portion of the article, and a second electrical resistivity in a second portion of the articles; and wherein the first resistivity and the second resistivity differ.

10. A method of making an electrothermal ice protection system comprising:
creating a polymer and carbon additive mixture;
forming a thermoplastic sheet from the polymer and carbon additive mixture; and
post-treating the polymer and carbon additive mixture.

11. The method of claim 10, wherein creating a polymer and carbon additive mixture comprises dissolving a base polymer resin and mixing the carbon additive into the base polymer resin.

12. The method of claim 10, wherein creating a polymer and carbon additive mixture comprises mixing a polymer resin and the carbon additive in a plastic compounding process.

13. The method of claim 12, wherein the plastic compounding process comprises heating the polymer resin to allow incorporation of the carbon additive to create a film.

14. The method of claim 13, wherein forming a thermoplastic sheet from the polymer and carbon additive mixture is done by placing the film into a cast to form a sheet.

15. The method of claim 10, wherein the thermoplastic sheet is made of a material selected from the group consisting of polyetherether ketones, polyetherimides, polyethlylenes, polyether sulfones, polylactic acid, nylon, polyethylene-naphthalates, polybenzimidazole, polyimides, poly methyl methacrylates and combinations thereof.

16. The method of claim 10, wherein the carbon allotrope additive is selected from the group consisting of carbon nanotubes, graphene, carbon nanofibers, graphite powder, and graphene nanoribbons.

17. The method of claim 10, wherein forming a sheet comprises molding the mixture into a complex shape.

18. The method of claim 10, wherein forming a mixture comprises injection the polymer with the carbon additive.

19. An ice protection system comprises:
a carbon heating element comprising a thermally stable thermoplastic sheet containing a carbon allotrope additive;
a first fiberglass layer adhered to the carbon heating element by a film adhesive;
a second fiberglass layer adhered to the carbon heating element opposite the first fiberglass layer by a film adhesive; and
a skin layer adhered to the second fiberglass layer opposite the carbon heating element by a film adhesive.

20. The ice protection system of claim 19, wherein the skin layer comprises a metallic layer or a composite layer.
